(19) United States
(12) Patent Application Publication
(10) Pub. No.: US 2021/0283602 A1
(43) Pub. Date: Sep. 16, 2021

(54) LIQUID HANDLING DEVICE AND LIQUID HANDLING METHOD

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 17/197,054

(22) Filed: Mar. 10, 2021

(30) Foreign Application Priority Data
Mar. 10, 2020 (JP) 2020-041019

(51) Int. Cl. B01L 3/00; G01N 35/08

(52) U.S. Cl. CPC B01L 3/502715; G01N 35/08; B01L 2300/0867; B01L 3/502738; B01L 2300/0816; B01L 3/502784

(57) ABSTRACT

A liquid handling device includes a common channel, a first liquid inlet channel connected to the common channel, a first liquid outlet channel connected to the common channel, a second liquid inlet channel connected to the common channel, and a second liquid outlet channel connected to the common channel. The ratio between the volume between the confluence part of the first liquid inlet channel and the confluence part of the first liquid outlet channel, and the volume between the confluence part of the second liquid inlet channel and the confluence part of the second liquid outlet channel in the common channel is X:Y. The liquid handling device can mix first liquid and second liquid in a volume ratio of X:Y.

### CROSS REFERENCE TO RELATED APPLICATIONS

This application is entitled to and claims the benefit of Japanese Patent Application No. 2020-041019, filed on Mar. 10, 2020, the disclosure of which including the specification, drawings and abstract is incorporated herein by reference in its entirety.

### TECHNICAL FIELD

The present invention relates to a liquid handling device and a liquid handling method for mixing first liquid and second liquid in a predetermined volume ratio.

### BACKGROUND ART

In recent years, channel chips have been used to analyze trace amounts of substances such as proteins and nucleic acids with high precision and speed. Channel chips have the advantage of requiring only a small amount of reagents and samples for analysis, and are expected to be used in a variety of applications such as clinical tests, food tests and environment tests.

In chips for various tests, it may be required to mix liquid of two types in a predetermined ratio, such as when a sample is diluted at a certain rate. For example, PTL 1 discloses that after a first droplet and a second droplet are generated, the first droplet and the second droplet are moved and fused together using electrowetting. PTL 2 discloses that aqueous solution (plug fluid) and reagent of a plurality of types are simultaneously introduced into a channel in which oil (fluid being carried) flows to generate a droplet (plug) containing the reagent of the plurality of types mixed together.

### CITATION LIST

### Patent Literature

### PTL 1

Japanese Unexamined Patent Application Publication (Translation of PCT Application) No. 2006-500596

### PTL 2

Japanese Patent Application Laid-Open No. 2019-141841

### SUMMARY OF INVENTION

### Technical Problem

In the technique disclosed in PTL 1 and the technique disclosed in PTL 2, liquid of two or more types are mixed while being measured at a certain accuracy using the interface tensile force and the like. In the technique disclosed in PTL 1 and the technique disclosed in PTL 2, however, each liquid is not mechanically measured using measuring flask or the like, and as such the weighing performance may be sacrificed for the materials in the liquid having an influence on the surface energy of the droplet.

An object of the present invention is to provide a liquid handling device and a liquid handling method that can mix liquid of two or more types while correctly measuring the liquid.

### Solution to Problem

A liquid handling device of an embodiment of the present invention is configured to mix first liquid and second liquid in a volume ratio of X:Y (X and Y are positive numbers), the liquid handling device including: a common channel; a first liquid inlet channel connected to the common channel; a first liquid inlet valve disposed in the first liquid inlet channel or a confluence part between the first liquid inlet channel and the common channel; a first liquid outlet channel connected to the common channel; a first liquid outlet valve disposed in the first liquid outlet channel or a confluence part between the first liquid outlet channel and the common channel; a second liquid inlet channel connected to the common channel; a second liquid inlet valve disposed in the second liquid inlet channel or a confluence part between the second liquid inlet channel and the common channel; a second liquid outlet channel connected to the common channel; and a second liquid outlet valve disposed in the second liquid outlet channel or a confluence part between the second liquid outlet channel and the common channel, wherein in the common channel, a ratio between a volume between a confluence part of the first liquid inlet channel and a confluence part the first liquid outlet channel and a volume between a confluence part of the second liquid inlet channel and a confluence part of the second liquid outlet channel is X:Y.

A liquid handling method of an embodiment of the present invention is a method of mixing the first liquid and the second liquid using the liquid handling device, the method including: introducing the first liquid from the first liquid inlet channel to the common channel until the first liquid goes over the confluence part of the first liquid outlet channel; removing, through the first liquid outlet channel, the first liquid that is present in a space not between the confluence part of the first liquid inlet channel and the confluence part of the first liquid outlet channel in the common channel; introducing the second liquid from the second liquid inlet channel to the common channel until the second liquid goes over the confluence part of the second liquid outlet channel; removing, through the second liquid outlet channel, the second liquid that is present in a space not between the confluence part of the second liquid inlet channel and the confluence part of the second liquid outlet channel in the common channel; and mixing the first liquid that is present between the confluence part of the first liquid inlet channel and the confluence part of the first liquid outlet channel in the common channel, and the second liquid that is present between the confluence part of the second liquid inlet channel and the confluence part of the second liquid outlet channel in the common channel.

### Advantageous Effects of Invention

According to the present invention, it is possible to provide a liquid handling device and a liquid handling method that can mix liquid of two or more types while correctly measuring the liquid.

### BRIEF DESCRIPTION OF DRAWINGS

FIG. 1A is a sectional view illustrating a configuration of a liquid handling system according to an embodiment, and FIG. 1B is a bottom view of a liquid handling device according to the embodiment;

FIG. 2A is a plan view of the liquid handling device according to the embodiment, FIG. 2B is a bottom view of the liquid handling device, and FIG. 2C is a bottom view of a substrate;

FIG. 3 is a bottom view for describing a configuration of the liquid handling device according to the embodiment;

FIG. 4A is a plan view of a first rotary member, and FIG. 4B is a sectional view taken along line B-B of FIG. 4A;

FIG. 5A is a plan view of a second rotary member, and FIG. 5B is a sectional view taken along line B-B of FIG. 5A;

FIGS. 6A and 6B are schematic views for describing operations of the liquid handling system and the liquid handling device according to the embodiment;

FIGS. 7A and 7B are schematic views for describing operations of the liquid handling system and the liquid handling device according to the embodiment; and

FIGS. 8A and 8B are schematic views for describing operations of the liquid handling system and the liquid handling device according to the embodiment.

### DESCRIPTION OF EMBODIMENTS

An embodiment of the present invention is elaborated below with reference to the accompanying drawings.

### Configurations of Liquid Handling System and Liquid Handling Device

In the present embodiment, a liquid handling system and a liquid handling device configured to mix first liquid and second liquid in a volume ratio of X:Y (X and Y are positive numbers) are described.

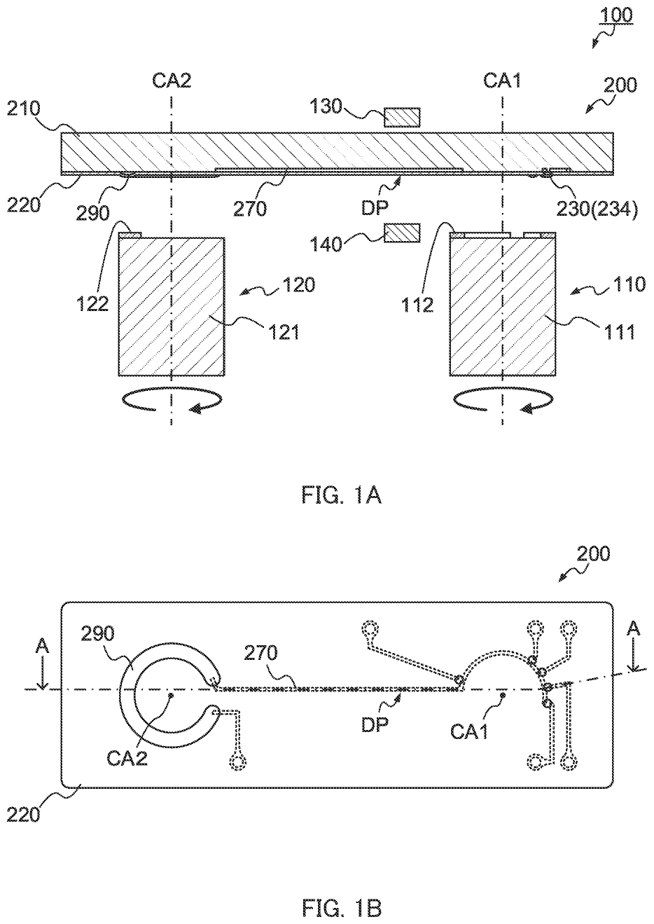

FIG. 1A is a sectional view illustrating a configuration of liquid handling system 100 according to the present embodiment. FIG. 1B is a bottom view of liquid handling device (channel chip) 200 according to the present embodiment. In FIG. 1B, inner channels and the like are illustrated with broken lines. The cross-section of liquid handling device 200 in FIG. 1A is a sectional view taken along line A-A of FIG. 1B.

As illustrated in FIG. 1A, liquid handling system 100 includes first rotary member 110, second rotary member 120, light source 130, light detector 140 and liquid handling device (channel chip) 200. First rotary member 110 is rotated around first central axis CA1 by an external driving mechanism not illustrated in the drawing. Second rotary member 120 is rotated around second central axis CA2 by an external driving mechanism not illustrated in the drawing. Liquid handling device 200 includes substrate 210 and film 220, and film 220 is installed such that film 220 makes contact with first rotary member 110 and second rotary member 120. Light source 130 and light detector 140 are disposed to sandwich liquid handling device 200 and configured to detect arrival of liquid at detection point DP in the channel set in liquid handling device 200. Note that in FIG. 1A, for the purpose of clearly illustrating the configuration of liquid handling system 100, the components are separated from each other.

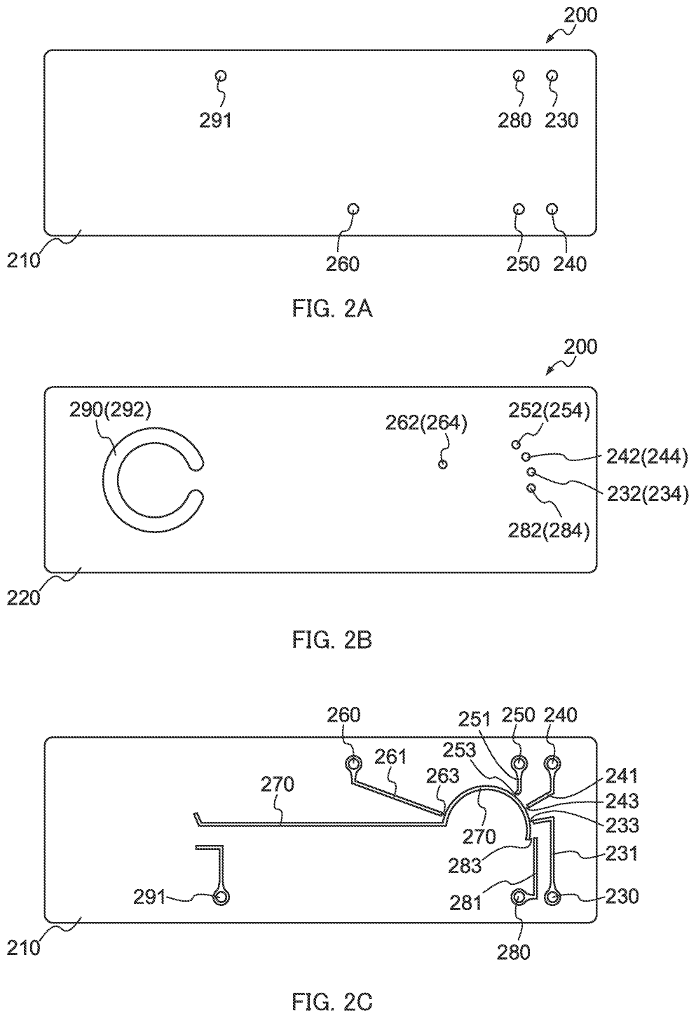

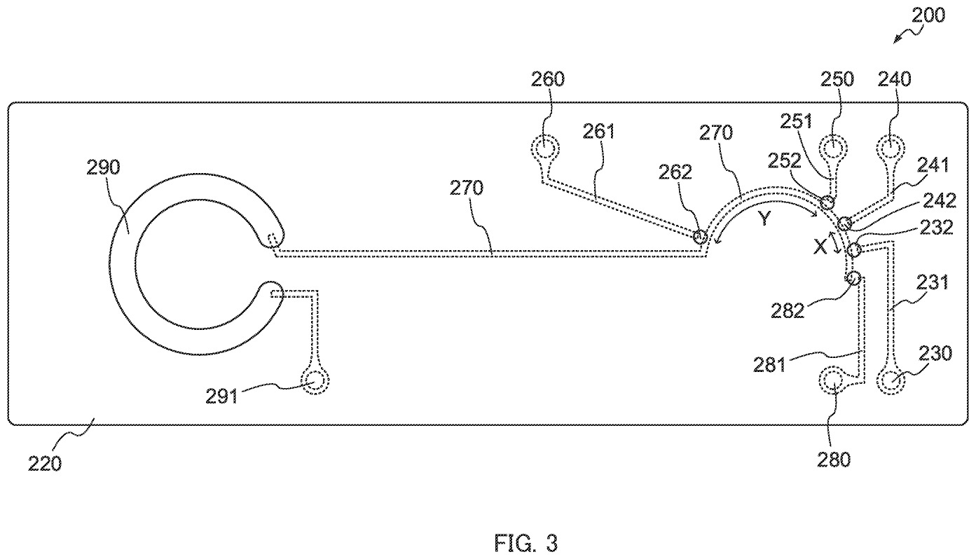

FIGS. 2A to 3 are drawings illustrating a configuration of liquid handling device 200. FIG. 2A is a plan view of liquid handling device 200 (a plan view of substrate 210). FIG. 2B is a bottom view of liquid handling device 200 (a bottom view of film 220). FIG. 2C is a bottom view of substrate 210 (a bottom view of liquid handling device 200 with film 220 removed). FIG. 3 is a bottom view for describing a configuration of liquid handling device 200 (the same drawing as FIG. 1B). In FIG. 3, grooves (channels) and the like formed in the surface substrate 210 on film 220 side are illustrated with broken lines.

As described above, liquid handling device 200 includes substrate 210 and film 220 (see FIG. 1A). In substrate 210, grooves configured to be channels and through holes configured to be inlet ports or ejection ports are formed. Film 220 is joined to one surface of substrate 210 to close the openings of the recess and the through hole formed in substrate 210. A part of the region of film 220 functions as a diaphragm. The groove of substrate 210 closed with film 220 serves as a channel for carrying fluid such as reagent, liquid sample, washing solution, gas, and powder.

The thickness of substrate 210 is not limited. For example, substrate 210 has a thickness of 1 mm to 10 mm. In addition, the material of substrate 210 is not limited. For example, the material of substrate 210 may be appropriately selected from publicly known resins and glass. Examples of the material of substrate 210 include polyethylene terephthalate, polycarbonate, polymethylmethacrylate, polyvinyl chloride, polypropylene, polyether, polyethylene, polystyrene, cyclo-olefin resin, silicone resin and elastomer.

The thickness of film 220 is not limited as long as it can function as a diaphragm. For example, the thickness of film 220 is 30 μm to 300 μm. In addition, the material of film 220 is not limited as long as it can function as a diaphragm. For example, the material of film 220 may be appropriately selected from publicly known resins. Examples of the material of film 220 include polyethylene terephthalate, polycarbonate, polymethylmethacrylate, polyvinyl chloride, polypropylene, polyether, polyethylene, polystyrene, cyclo-olefin resin, silicone resin and elastomer. For example, film 220 is joined to substrate 210 by thermal welding, laser welding, an adhesive agent and the like.

As illustrated in FIG. 3, liquid handling device 200 according to the present embodiment includes first liquid inlet port 230, first liquid inlet channel 231, first liquid inlet valve 232, first liquid outlet port 240, first liquid outlet channel 241, first liquid outlet valve 242, second liquid inlet port 250, second liquid inlet channel 251, second liquid inlet valve 252, second liquid outlet port 260, second liquid outlet channel 261, second liquid outlet valve 262, common channel 270, liquid mixture well 280, liquid collection channel 281, liquid collection valve 282, rotary membrane pump 290 and ventilation hole 291.

First liquid inlet port 230 is a bottomed recess configured to introduce first liquid into liquid handling device 200. First liquid outlet port 240 is a bottomed recess configured to remove excess first liquid from the inside of liquid handling device 200. Second liquid inlet port 250 is a bottomed recess configured to introduce second liquid into liquid handling device 200. Second liquid outlet port 260 is a bottomed recess configured to remove excess second liquid from the inside of liquid handling device 200. Liquid mixture well 280 is a bottomed recess configured to mix the first liquid and the second liquid measured in common channel 270.

In the present embodiment, each of the recesses is composed of a through hole formed in substrate 210 and film 220 that closes one opening of the through hole. The shape and the size of each recess are not limited and may be appropriately set in accordance with the use. The shape of each recess is, for example, a substantially columnar shape. The width of each recess is, for example, approximately 2 mm. The type of the liquid to be housed in first liquid inlet port 230 or second liquid inlet port 250 is appropriately selected in accordance with the use of liquid handling device 200. The liquid is reagent, a liquid sample, or diluted solution.

First liquid inlet channel 231, first liquid outlet channel 241, second liquid inlet channel 251, second liquid outlet channel 261 and liquid collection channel 281 are channels in which fluid can move. The upstream ends of first liquid inlet channel 231 and second liquid inlet channel 251 are connected to first liquid inlet port 230 and second liquid inlet port 250, respectively. The downstream ends of first liquid inlet channel 231 and second liquid inlet channel 251 are connected to common channel 270 at respective positions different from each other. The upstream ends of first liquid outlet channel 241, second liquid outlet channel 261 and liquid collection channel 281 are connected to common channel 270 at respective positions different from each other. The downstream ends of first liquid outlet channel 241, second liquid outlet channel 261 and liquid collection channel 281 are connected to first liquid outlet port 240, second liquid outlet port 260 and liquid mixture well 280, respectively.

In the present embodiment, each of the channels is composed of a groove formed in substrate 210 and film 220 that closes the opening of the groove. The cross-sectional area and the cross-sectional shape of each channel are not limited. The “cross-section of channel” as used herein means the cross-section of a channel orthogonal to the flow direction of the liquid. The cross-sectional shape of each channel is, for example, a substantially rectangular shape with each side (width and depth) having a length of approximately several tens of micrometers. The cross-sectional area of each channel may be or may not be constant in the flow direction of the fluid. In the present embodiment, the cross-sectional area of each channel is constant.

First liquid inlet valve 232, first liquid outlet valve 242, second liquid inlet valve 252, second liquid outlet valve 262 and liquid collection valve 282 are membrane valves (diaphragm valves) that control the flow of the liquid in first liquid inlet channel 231, first liquid outlet channel 241, second liquid inlet channel 251, second liquid outlet channel 261 and liquid collection channel 281, respectively. In the present embodiment, these valves are rotary membrane valves whose opening and closing are controlled by rotation of first rotary member 110. In the present embodiment, these valves are disposed on the circumference of one circle centered on central axis CAL

First liquid inlet valve 232 is disposed in first liquid inlet channel 231 or the confluence part between first liquid inlet channel 231 and common channel 270. Likewise, first liquid outlet valve 242 is disposed in first liquid outlet channel 241 or the confluence part between first liquid outlet channel 241 and common channel 270. Second liquid inlet valve 252 is disposed in second liquid inlet channel 251 or the confluence part between second liquid inlet channel 251 and common channel 270. Second liquid outlet valve 262 is disposed in second liquid outlet channel 261 or the confluence part between second liquid outlet channel 261 and common channel 270. Liquid collection valve 282 is disposed in liquid collection channel 281 or the confluence part between liquid collection channel 281 and common channel 270. In the present embodiment, first liquid inlet valve 232 is disposed in the confluence part between first liquid inlet channel 231 and common channel 270, first liquid outlet valve 242 is disposed in the confluence part between first liquid outlet channel 241 and common channel 270, second liquid inlet valve 252 is disposed in the confluence part between second liquid inlet channel 251 and common channel 270, second liquid outlet valve 262 is disposed in the confluence part between second liquid outlet channel 261 and common channel 270, and liquid collection valve 282 is disposed in the confluence part between liquid collection channel 281 and common channel 270.

First liquid inlet valve 232 includes partition wall 233 and diaphragm 234. Likewise, first liquid outlet valve 242 includes partition wall 243 and diaphragm 244. Second liquid inlet valve 252 includes partition wall 253 and diaphragm 254. Second liquid outlet valve 262 includes partition wall 263 and diaphragm 264. Liquid collection valve 282 includes partition wall 283 and diaphragm 284.

In the present embodiment, partition wall 233 of first liquid inlet valve 232 is disposed between first liquid inlet channel 231 and common channel 270. Diaphragm 234 of first liquid inlet valve 232 is disposed opposite to partition wall 233. Likewise, partition wall 243 of first liquid outlet valve 242 is disposed between first liquid outlet channel 241 and common channel 270. Diaphragm 244 of first liquid outlet valve 242 is disposed opposite to partition wall 243. Partition wall 253 of second liquid inlet valve 252 is disposed between second liquid inlet channel 251 and common channel 270. Diaphragm 254 of second liquid inlet valve 252 is disposed opposite to partition wall 253. Partition wall 263 of second liquid outlet valve 262 is disposed between second liquid outlet channel 261 and common channel 270. Diaphragm 264 of second liquid outlet valve 262 is disposed opposite to partition wall 263. Partition wall 283 of liquid collection valve 282 is disposed between liquid collection channel 281 and common channel 270. Diaphragm 284 of liquid collection valve 282 is disposed opposite to partition wall 283.

Partition wall 233 of first liquid inlet valve 232 functions as a valve seat of a membrane valve (diaphragm valve) for opening and closing between first liquid inlet channel 231 and common channel 270. Likewise, partition wall 243 of first liquid outlet valve 242 functions as a valve seat of a membrane valve for opening and closing between common channel 270 and first liquid outlet channel 241. Partition wall 253 of second liquid inlet valve 252 functions as a valve seat of a membrane valve for opening and closing between second liquid inlet channel 251 and common channel 270. Partition wall 263 of second liquid outlet valve 262 functions as a valve seat of a membrane valve for opening and closing between common channel 270 and second liquid outlet channel 261. Partition wall 283 of liquid collection valve 282 functions as a valve seat of a membrane valve for opening and closing between common channel 270 and liquid collection channel 281. The shape and the height of the partition walls are not limited as long as the above-mentioned functions can be ensured. The shape of each partition wall is, for example, a quadrangular prism shape. The height of each partition wall is, for example, the same as the depth of each channel.

Each of diaphragm 234 of first liquid inlet valve 232, diaphragm 244 of first liquid outlet valve 242, diaphragm 254 of second liquid inlet valve 252, diaphragm 264 of second liquid outlet valve 262, and diaphragm 284 of liquid collection valve 282 is a part of flexible film 220, and has a substantially spherical cap shape (dome shape) (see FIG. 1A). Film 220 is disposed on substrate 210 such that each diaphragm faces the corresponding partition wall in a noncontact manner.

Diaphragm 234 of first liquid inlet valve 232, diaphragm 244 of first liquid outlet valve 242, diaphragm 254 of second liquid inlet valve 252, diaphragm 264 of second liquid outlet valve 262, and diaphragm 284 of liquid collection valve 282 deflect toward the corresponding partition walls when pressed by first protrusion 112 (described later) of first rotary member 110. In this manner, the diaphragms function as valve elements of diaphragm valves. For example, when first protrusion 112 is not pressing diaphragm 234 of first liquid inlet valve 232, first liquid inlet channel 231 and common channel 270 are communicated with each other through the gap between diaphragm 234 and partition wall 233. On the other hand, when first protrusion 112 is pressing diaphragm 234 such that diaphragm 234 makes contact with partition wall 233, first liquid inlet channel 231 and common channel 270 are not communicated with each other.

Common channel 270 is a channel in which fluid can move. Common channel 270 is connected to first liquid inlet channel 231, first liquid outlet channel 241, second liquid inlet channel 251, second liquid outlet channel 261 and liquid collection channel 281. Accordingly, first liquid introduced to first liquid inlet port 230 and second liquid introduced to second liquid inlet port 250 flow through common channel 270. The downstream end of common channel 270 is connected to rotary membrane pump 290. In the present embodiment, common channel 270 is composed of a groove formed in substrate 210 and film 220 that closes the opening of the groove. The cross-sectional area and the cross-sectional shape of common channel 270 are not limited. The cross-sectional shape of common channel 270 is, for example, a substantially rectangular shape with each side (width and depth) having a length of approximately several tens of micrometers. The cross-sectional area of common channel 270 may be or may not be constant in the flow direction of the fluid. In the present embodiment, the cross-sectional area of common channel 270 is constant.

Rotary membrane pump 290 is a space having a substantially arc-shape (C-shape) in plan view and is formed between substrate 210 and film 220. The upstream end of rotary membrane pump 290 is connected to common channel 270, and the downstream end of rotary membrane pump 290 is connected to ventilation hole 291. In the present embodiment, rotary membrane pump 290 is composed of the bottom surface of substrate 210 and diaphragm 292 facing the bottom surface with a space therebetween. Diaphragm 292 is a part of flexible film 220 (see FIG. 1A). Diaphragm 292 is disposed on the circumference of one circle centered on central axis CA2. The cross-sectional shape of diaphragm 292 in the direction orthogonal to the circumference is not limited, and is an arc-shape in the present embodiment.

Diaphragm 292 of rotary membrane pump 290 is deflected to make contact with substrate 210 when pressed by second protrusion 122 (described later) of second rotary member 120. For example, when second protrusion 122 presses diaphragm 292 while making sliding contact with it from the connecting part with common channel 270 toward the connecting part with ventilation hole 291 (counterclockwise in FIG. 3), the inside of common channel 270 is set to a negative pressure such that the fluid inside common channel 270 moves toward rotary membrane pump 290 and that the liquid inside first liquid inlet channel 231 or second liquid inlet channel 251 moves into common channel 270. On the other hand, when second protrusion 122 presses diaphragm 292 while making sliding contact with it from the connecting part with ventilation hole 291 toward the connecting part with common channel 270 (clockwise in FIG. 3), the inside of common channel 270 is set to a positive pressure such that the fluid inside rotary membrane pump 290 moves toward common channel 270 and that the liquid inside common channel 270 moves into first liquid outlet channel 241, second liquid outlet channel 261 or liquid collection channel 281.

Ventilation hole 291 is a bottomed recess configured to introduce fluid (e.g., air) into rotary membrane pump 290 and discharge the fluid (e.g., air) inside rotary membrane pump 290 when second protrusion 122 of second rotary member 120 presses diaphragm 292 of rotary membrane pump 290 while making sliding contact with it. In the present embodiment, ventilation hole 291 is composed of a through hole formed in substrate 210 and film 220 that closes one opening of the through hole. The shape and the size of ventilation hole 291 are not limited, and may be appropriately set as necessary. The shape of ventilation hole 291 is, for example, a substantially columnar shape. The width of ventilation hole 291 is, for example approximately 2 mm.

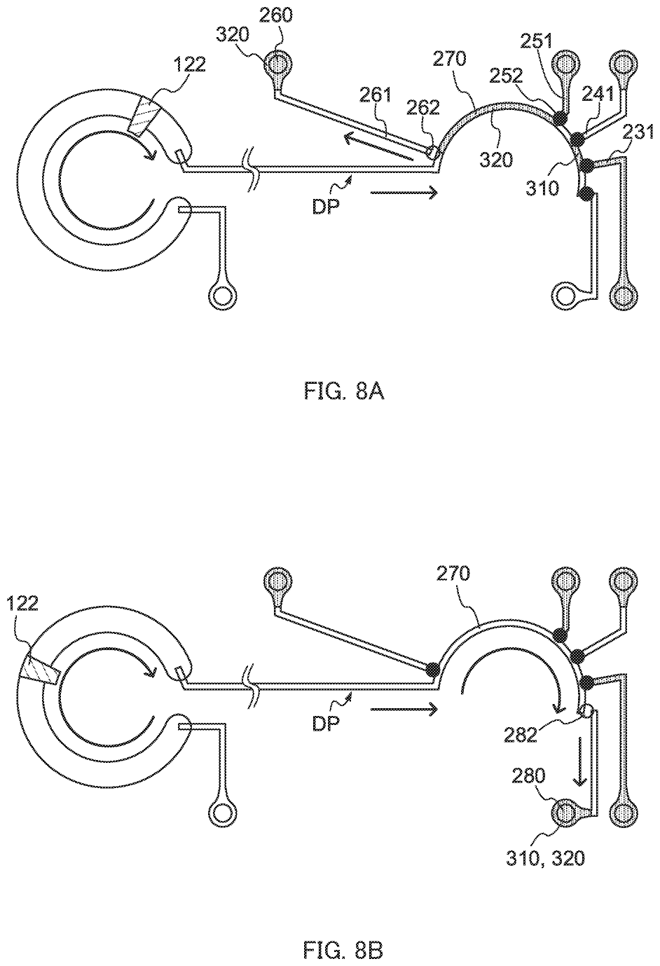

As described above, liquid handling device 200 according to the present embodiment is used to mix the first liquid and the second liquid in a volume ratio of X:Y (X and Y are positive numbers). To achieve this object, liquid handling device 200 is configured such that the ratio between the volume between the confluence part of first liquid inlet channel 231 and the confluence part of first liquid outlet channel 241 and the volume between the confluence part of second liquid inlet channel 251 and the confluence part of second liquid outlet channel 261 is X:Y in common channel 270. As illustrated in FIG. 3, in the present embodiment, the cross-sectional area of common channel 270 is constant, and, in common channel 270, the ratio between the distance between the confluence part of first liquid inlet channel 231 and the confluence part of first liquid outlet channel 241 and the distance between the confluence part of second liquid inlet channel 251 and the confluence part of second liquid outlet channel 261 is X:Y. In this manner, first liquid 310 can be mechanically measured using the space between the confluence part of first liquid inlet channel 231 and the confluence part of first liquid outlet channel 241 in common channel 270, and second liquid 320 can be mechanically measured using the space between the confluence part of second liquid inlet channel 251 and the confluence part of second liquid outlet channel 261 in common channel 270 (see FIG. 8A).

In common channel 270, each of the confluence part of first liquid inlet channel 231 and the confluence part of first liquid outlet channel 241 is preferably disposed in a region not between the confluence part of second liquid inlet channel 251 and the confluence part of second liquid outlet channel 261. Likewise, in common channel 270, each of the confluence part of second liquid inlet channel 251 and the confluence part of second liquid outlet channel 261 is preferably disposed in a region not between the confluence part of first liquid inlet channel 231 and the confluence part of first liquid outlet channel 241. With each channel disposed in the above-mentioned manner, measured first liquid 310 and measured second liquid 320 is allowed to be simultaneously present in common channel 270 (see FIG. 8A).

In addition, in the case where liquid handling device 200 is operated using one pump (rotary membrane pump 290) as in the present embodiment, it is preferable that in common channel 270, the confluence part of first liquid outlet channel 241 be disposed on the one end portion side of common channel 270 than the confluence part of first liquid inlet channel 231, and the confluence part of second liquid outlet channel 261 be disposed on the one end portion side than the confluence part of second liquid inlet channel 251. To be more specific, in the case where one pump (rotary membrane pump 290) is connected to the downstream end portion of common channel 270, it is preferable that in common channel 270, the confluence part of first liquid outlet channel 241 be disposed on the downstream side of common channel 270 than the confluence part of first liquid inlet channel 231, and the confluence part of second liquid outlet channel 261 be disposed on the downstream side than the confluence part of second liquid inlet channel 251. It should be noted that in the case where liquid handling device 200 is operated using a plurality of pumps unlike the present embodiment, each channel may be more freely disposed.

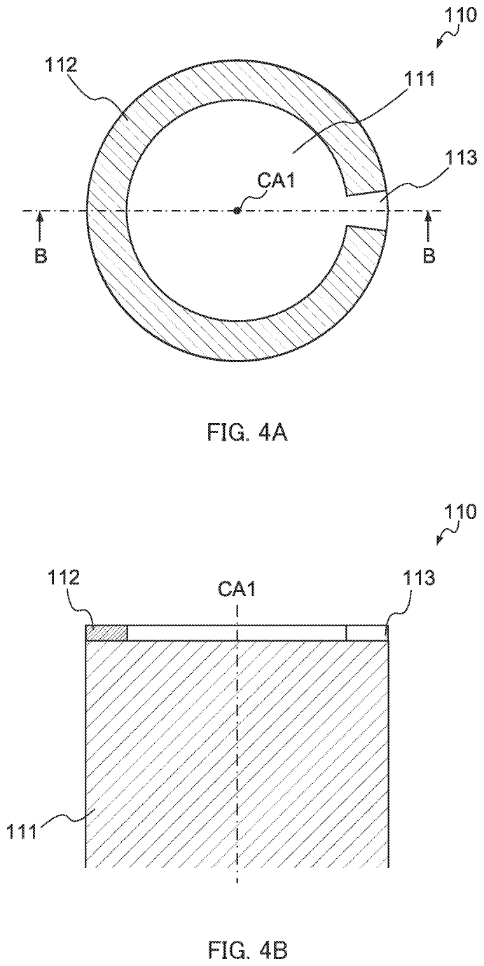

FIG. 4A is a plan view of first rotary member 110, and FIG. 4B is a sectional view taken along line B-B of FIG. 4A. In FIG. 4A, for the sake of clarity, the top surface of first protrusion 112 is hatched.

First rotary member 110 includes columnar first body 111, first protrusion 112 disposed on the top surface of first body 111, and first recess 113 disposed on the top surface of first body 111. First body 111 is rotatable about first central axis CAL First body 111 is rotated by the external driving mechanism not illustrated in the drawing.

In the upper part of first body 111, first protrusion 112 and first recess 113 are provided. First protrusion 112 is configured to close first liquid inlet valve 232, first liquid outlet valve 242, second liquid inlet valve 252, second liquid outlet valve 262 and liquid collection valve 282 by pressing diaphragm 234, diaphragm 244, diaphragm 254, diaphragm 264 and diaphragm 284, and first recess 113 is configured to open the valves without pressing the diaphragms. First protrusion 112 and first recess 113 are disposed on the circumference of a circle centered on central axis CAL In the present embodiment, the shape of first protrusion 112 in plan view is an arc-shape (C-shape) corresponding to a part of a circle centered on central axis CAL The region where first protrusion 112 is not provided on the circumference is first recess 113.

Note that it suffices that first protrusion 112 is relatively protruded than first recess 113, and that first recess 113 is relatively recessed than first protrusion 112. That is, it suffices that first protrusion 112 can function as a pressure part and that first recess 113 can function as a non-pressure part. For example, in the example illustrated in FIG. 4B, first protrusion 112 is protruded from the top surface (reference surface) of first body 111, and the bottom surface of first recess 113 is a surface at the same height as the top surface of first body 111 (reference surface). Conversely, the top surface of first protrusion 112 may be a surface at the same height as the top surface of first body 111 (reference surface), and in that case, first recess 113 is recessed from the top surface of first body 111 (reference surface).

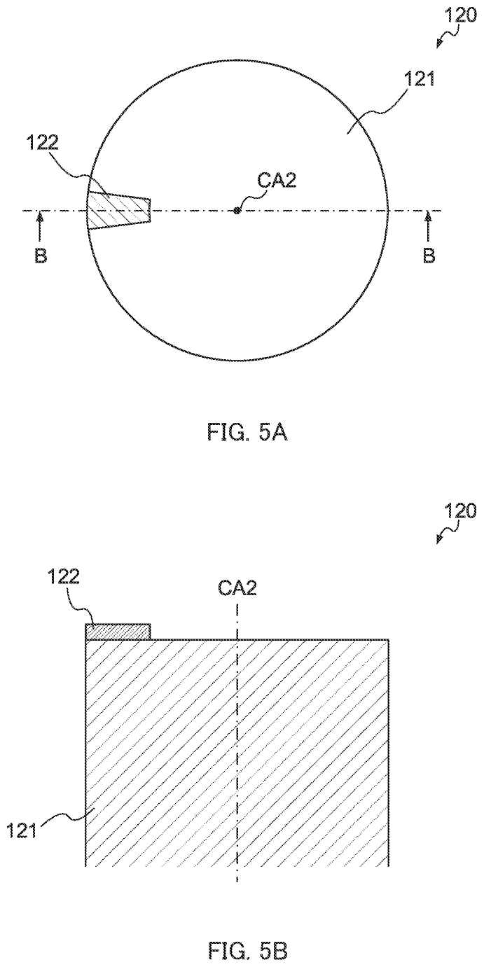

FIG. 5A is a plan view of second rotary member 120, and FIG. 5B is a sectional view taken along line B-B of FIG. 5A. In FIG. 5A, for the sake of clarity, the top surface of second protrusion 122 is hatched.

Second rotary member 120 includes columnar second body 121 and second protrusion 122 disposed on the top surface of second body 121. Second body 121 is rotatable about second central axis CA2. Second body 121 is rotated by the external driving mechanism not illustrated in the drawing.

In the upper part of second body 121, second protrusion 122 configured to operate rotary membrane pump 290 by pressing diaphragm 292 while making sliding contact with it is provided. Second protrusion 122 is disposed on the circumference of a circle centered on central axis CA2. The shape of second protrusion 122 is not limited as long as rotary membrane pump 290 can be appropriately operated. In the present embodiment, the shape of second protrusion 122 in plan view is an arc-shape corresponding to a part of a circle centered on central axis CA2.

Light source 130 applies light to detection point DP set at a predetermined position in common channel 270. Light detector 140 detects light from detection point DP of common channel 270 to detect whether liquid has reached detection point DP. The wavelength of the light emitted by light source 130 is not limited as long as light detector 140 can detect (the liquid surface of) the liquid, and is appropriately set in accordance with the type of the liquid to be introduced into common channel 270. For example, light source 130 is an infrared light-emitting diode, and light detector 140 is a phototransistor.

Operations of Liquid Handling System and Liquid Handling Device

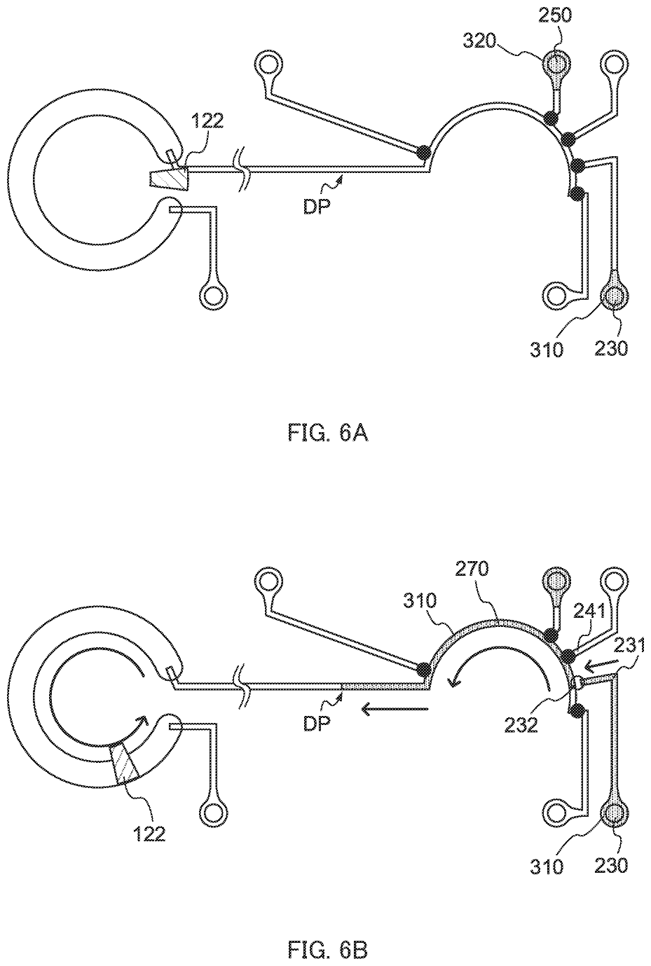

Next, with reference to FIGS. 6A to 8B, operations of liquid handling system 100 and liquid handling device 200 are described. For convenience of description, in FIGS. 6A to 8B, first liquid inlet valve 232, first liquid outlet valve 242, second liquid inlet valve 252, second liquid outlet valve 262 and liquid collection valve 282 are illustrated with black circles when they are pressed and closed by first protrusion 112 of first rotary member 110, and are illustrated with blank circles when they face first recess 113 without being closed.

First, as illustrated in FIG. 6A, first liquid (e.g., a sample such as blood) 310 is introduced to first liquid inlet port 230, and second liquid (e.g., diluted solution for a sample) 320 is introduced to second liquid inlet port 250. At this time, all valves are closed.

Next, first rotary member 110 is rotated to open first liquid inlet valve 232, and second rotary member 120 is rotated to cause rotary membrane pump 290 to suction the fluid (e.g., air) inside common channel 270. In this manner, as illustrated in FIG. 6B, first liquid 310 in first liquid inlet port 230 is introduced into common channel 270 from first liquid inlet channel 231. At this time, until first liquid 310 goes over the confluence part of first liquid outlet channel 241 (in the present embodiment, the portion where first liquid outlet valve 242 is disposed), first liquid 310 is introduced into common channel 270. In the present embodiment, light source 130 applies light to detection point DP set in common channel 270, and light detector 140 detects light from detection point DP, and thus, the start position of first liquid 310 introduced into common channel 270 is detected. When first liquid 310 has reached detection point DP, the rotation of second rotary member 120 is stopped to stop the suction at rotary membrane pump 290.

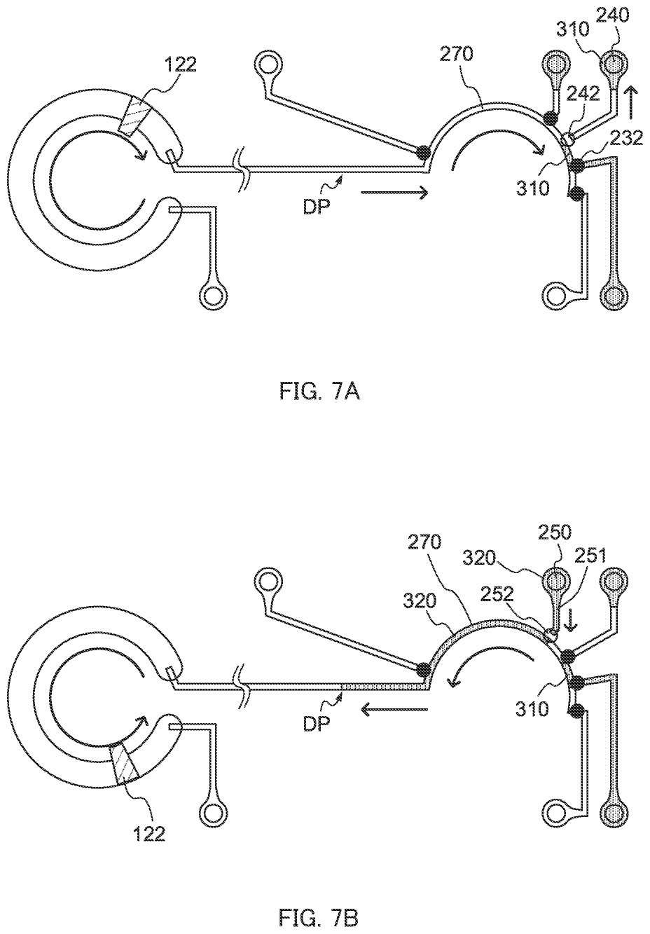

Next, first rotary member 110 is rotated to open only first liquid outlet valve 242, and second rotary member 120 is rotated to cause rotary membrane pump 290 to push out the fluid inside common channel 270. In this manner, as illustrated in FIG. 7A, first liquid 310 that is present in a space not between the confluence part of first liquid inlet channel 231 (in the present embodiment, the portion where first liquid inlet valve 232 is disposed) and the confluence part of first liquid outlet channel 241 (in the present embodiment, the portion where first liquid outlet valve 242 is disposed) in common channel 270 is moved to first liquid outlet port 240 and removed. At this time, first liquid 310 that is present between the confluence part of first liquid inlet channel 231 and the confluence part of first liquid outlet channel 241 in common channel 270 remains in common channel 270 without being moved.

Next, first rotary member 110 is rotated to open only second liquid inlet valve 252, and second rotary member 120 is rotated to cause rotary membrane pump 290 to suction the fluid inside common channel 270. In this manner, as illustrated in FIG. 7B, second liquid 320 in second liquid inlet port 250 is introduced into common channel 270. Also at this time, until second liquid 320 goes over the confluence part of second liquid outlet channel 261 (in the present embodiment, the portion where second liquid outlet valve 262 is disposed), second liquid 320 is introduced into common channel 270. In the present embodiment, light detector 140 detects light from detection point DP, and thus the start position of second liquid 320 introduced into common channel 270 is detected. When second liquid 320 has reached detection point DP, the rotation of second rotary member 120 is stopped to stop the suction at rotary membrane pump 290.

Next, first rotary member 110 is rotated to open only second liquid outlet valve 262, and second rotary member 120 is rotated to cause rotary membrane pump 290 to push out the fluid inside common channel 270. In this manner, as illustrated in FIG. 8A, second liquid 320 that is present in a space not between the confluence part of second liquid inlet channel 251 (in the present embodiment, the portion where second liquid inlet valve 252 is disposed) and the confluence part of second liquid outlet channel 261 (in the present embodiment, the portion where second liquid outlet valve 262 is disposed) in common channel 270 is moved to second liquid outlet port 260 and removed. However, second liquid 320 that is present between the confluence part of second liquid inlet channel 251 and the confluence part of second liquid outlet channel 261 in common channel 270 remains in common channel 270 without being moved.

As described above, in the state illustrated in FIG. 8A, in common channel 270, first liquid 310 is present only between the confluence part of first liquid inlet channel 231 (in the present embodiment, the portion where first liquid inlet valve 232 is disposed) and the confluence part of first liquid outlet channel 241 (in the present embodiment, the portion where first liquid outlet valve 242 is disposed), and second liquid 320 is present only between the confluence part of second liquid inlet channel 251 (in the present embodiment, the portion where second liquid inlet valve 252 is disposed) and the confluence part of second liquid outlet channel 261 (in the present embodiment, the portion where second liquid outlet valve 262 is disposed). Then, in liquid handling device 200 according to the present embodiment, the ratio between the volume of the space between the confluence part of first liquid inlet channel 231 and the confluence part of first liquid outlet channel 241 and the volume of the space between the confluence part of second liquid inlet channel 251 and the confluence part of second liquid outlet channel 261 in common channel 270 is X:Y. Accordingly, in the state illustrated in FIG. 8A, the volume ratio between first liquid 310 and second liquid 320 that are present in common channel 270 is X:Y.

Finally, first rotary member 110 is rotated to open only liquid collection valve 282, and second rotary member 120 is rotated to cause rotary membrane pump 290 to push out the fluid inside common channel 270. In this manner, as illustrated in FIG. 8B, first liquid 310 and second liquid 320 in common channel 270 are moved to liquid mixture well 280 and mixed.

Through the above-mentioned procedure, first liquid 310 and second liquid 320 can be mixed in a volume ratio of X:Y.

### Effect

As described above, with liquid handling system 100 and liquid handling device 200 according to the present embodiment, the volumes of first liquid 310 and second liquid 320 can be mechanically measured and first liquid 310 and second liquid 320 can be mixed in a volume ratio of X:Y.

Note that while an example of liquid handling device 200 including a rotary membrane valve and a rotary membrane pump is described in the present embodiment, the present invention is not limited to this. For example, each valve may be a valve having a configuration other than that of rotary membrane valves. In addition, each channel may be connected to a pump other than rotary membrane pump.

In addition, while an example of liquid handling device 200 configured to mix liquid of two types is described in the present embodiment, the present invention is not limited to this. For example, the fluid handling device may be configured to mix liquid of three or more types.

### INDUSTRIAL APPLICABILITY

For example, the liquid handling device of the embodiment of the present invention is useful for various uses such as laboratory tests, food tests and environment tests.

### REFERENCE SIGNS LIST

100 Liquid handling system
110 First rotary member
111 First body
112 First protrusion
113 First recess
120 Second rotary member
121 Second body
122 Second protrusion
130 Light source
140 Light detector
200 Liquid handling device
210 Substrate
220 Film
230 First liquid inlet port
231 First liquid inlet channel
232 First liquid inlet valve
233 Partition wall
234 Diaphragm
240 First liquid outlet port
241 First liquid outlet channel
242 First liquid outlet valve
243 Partition wall
244 Diaphragm
250 Second liquid inlet port
251 Second liquid inlet channel
252 Second liquid inlet valve
253 Partition wall
254 Diaphragm
260 Second liquid outlet port
261 Second liquid outlet channel
262 Second liquid outlet valve
263 Partition wall
264 Diaphragm
270 Common channel
280 Liquid mixture well
281 Liquid collection channel
282 Liquid collection valve
283 Partition wall
284 Diaphragm
290 Rotary membrane pump
291 Ventilation hole
292 Diaphragm
310 First liquid
320 Second liquid
CA1, CA2 Central axis
DP Detection point

1. A liquid handling device configured to mix first liquid and second liquid in a volume ratio of X:Y (X and Y are positive numbers), the liquid handling device comprising:
a common channel;
a first liquid inlet channel connected to the common channel;
a first liquid inlet valve disposed in the first liquid inlet channel or a confluence part between the first liquid inlet channel and the common channel;
a first liquid outlet channel connected to the common channel;
a first liquid outlet valve disposed in the first liquid outlet channel or a confluence part between the first liquid outlet channel and the common channel;
a second liquid inlet channel connected to the common channel;
a second liquid inlet valve disposed in the second liquid inlet channel or a confluence part between the second liquid inlet channel and the common channel;
a second liquid outlet channel connected to the common channel; and
a second liquid outlet valve disposed in the second liquid outlet channel or a confluence part between the second liquid outlet channel and the common channel,
wherein in the common channel, a ratio between a volume between a confluence part of the first liquid inlet channel and a confluence part the first liquid outlet channel and a volume between a confluence part of the second liquid inlet channel and a confluence part of the second liquid outlet channel is X:Y.

2. The liquid handling device according to claim 1,
wherein in the common channel,
each of the confluence part of the first liquid inlet channel and the confluence part of the first liquid outlet channel is disposed in a region not between the confluence part of the second liquid inlet channel and the confluence part of the second liquid outlet channel; and
each of the confluence part of the second liquid inlet channel and the confluence part of the second liquid outlet channel is disposed in a region not between the confluence part of the first liquid inlet channel and the confluence part of the first liquid outlet channel.

3. The liquid handling device according to claim 1,
wherein in the common channel,
the confluence part of the first liquid outlet channel is disposed on one end portion side of the common channel than the confluence part of the first liquid inlet channel; and
the confluence part of the second liquid outlet channel is disposed on the one end portion side than the confluence part of the second liquid inlet channel.

4. The liquid handling device according to claim 1,
wherein a cross-sectional area of the common channel in a direction orthogonal to a flow direction is constant; and
wherein, in the common channel, a ratio between a distance between the confluence part of the first liquid inlet channel and the confluence part of the first liquid outlet channel and a distance between the confluence part of the second liquid inlet channel and the confluence part of the second liquid outlet channel is X:Y.

5. The liquid handling device according to claim 1, further comprising a liquid mixture well connected to the common channel.

6. The liquid handling device according to claim 1, wherein the first liquid inlet valve, the first liquid outlet valve, the second liquid inlet valve and the second liquid outlet valve are rotary membrane valves.

7. The liquid handling device according to claim 6, wherein the first liquid inlet valve, the first liquid outlet valve, the second liquid inlet valve and the second liquid outlet valve are disposed on a circumference of one circle.

8. The liquid handling device according to claim 1, further comprising a rotary membrane pump connected to the common channel.

9. A liquid handling method of mixing the first liquid and the second liquid using the liquid handling device according to claim 1, the method comprising:
introducing the first liquid from the first liquid inlet channel to the common channel until the first liquid goes over the confluence part of the first liquid outlet channel;
removing, through the first liquid outlet channel, the first liquid that is present in a space not between the confluence part of the first liquid inlet channel and the confluence part of the first liquid outlet channel in the common channel;
introducing the second liquid from the second liquid inlet channel to the common channel until the second liquid goes over the confluence part of the second liquid outlet channel;
removing, through the second liquid outlet channel, the second liquid that is present in a space not between the confluence part of the second liquid inlet channel and the confluence part of the second liquid outlet channel in the common channel; and
mixing the first liquid that is present between the confluence part of the first liquid inlet channel and the confluence part of the first liquid outlet channel in the common channel, and the second liquid that is present between the confluence part of the second liquid inlet channel and the confluence part of the second liquid outlet channel in the common channel.
